(19) United States
(12) Patent Application Publication
(10) Pub. No.: US 2025/0273206 A1
(43) Pub. Date: Aug. 28, 2025

(54) SCENE CREATION METHOD AND EQUIPMENT AND CORRESPONDING VEHICLES, COMPUTING DEVICE AND MEDIA

(71) Applicant: CARIAD (CHINA) CO., LTD., Beijing (CN)

(72) Inventors: Jianfei CAI, Beijing (CN); Nannan LI, Beijing (CN); Zhongbo JIANG, Beijing (CN); Zhimin GU, Beijing (CN)

(21) Appl. No.: 19/002,511

(22) Filed: Dec. 26, 2024

(30) Foreign Application Priority Data
Dec. 26, 2023 (CN) 202311809053.3

(51) Int. Cl. G10L 15/18; B60R 16/037; G10L 15/22

(52) U.S. Cl. CPC G10L 15/1815; G10L 15/1822; G10L 15/22; B60R 16/0373

(57) ABSTRACT

The present disclosure provides a scenario creation method and device for the vehicle, a corresponding vehicle, a computer device, and a non-transitory computer-readable storage medium. The method includes: a receiving step: receiving a speech input from a user of the vehicle; a parsing and determining step: parsing the speech input and determining whether the speech input indicates a scenario creation intention to create a scenario; an acquiring step: in the event of a positive determination result, acquiring scenario description information related to the scenario to be created; and a generating step: on the basis of the scenario description information, generating a scenario file for scenario creation. With the solution of the present disclosure, the vehicle user can realize scenario creation simply by providing speech input, enabling scenario creation to be triggered and realized with a natural language under various circumstances, without limitations. Therefore, the present disclosure eliminates the need for parking or other safety conditions required by existing scenario creation solutions, while offering a user-friendly method for scenario creation.

### TECHNICAL FIELD

The present disclosure relates to the field of vehicles, and more particularly, to a scenario creation method and device for a vehicle, a corresponding vehicle, a computer device, and a non-transitory computer-readable storage medium.

### BACKGROUND

Modern vehicles often feature scenarios/modes that include a combination of services. When a user activates such scenario/mode in a specific environment, it triggers the adjustment of a relevant device in the vehicle to an expected state. Currently, most of these scenarios/modes are preset by vehicle manufacturers, and when creating and generating such scenarios/modes, the vehicle manufacturers generally use some visual editing tools. These tools generally require a certain understanding of system terminology and demand a level of professionalism, along with strong logical reasoning or programming skills. If such tools are made available to users for creating scenarios/modes, they may be presented as visual scenarios through a mobile App, allowing users to perform drag-and-drop operations.

However, although existing visual editing tools (such as Z-ONE's Z-ONE Studio Lite and NIO's scenario editor) offer users some level of custom editing capabilities, they remain complex for ordinary users. In addition, existing visual editing tools typically require being used when the vehicle is parked or under other safe conditions, which limits the ability of vehicle users to create scenarios.

### SUMMARY

An object of the present disclosure is to provide a scenario creation solution for a vehicle to solve at least part of the problems hereinabove.

According to a first aspect of the present disclosure, provided is a scenario creation method for a vehicle, including:
a receiving step: receiving a speech input from a user of the vehicle;
a parsing and determining step: parsing the speech input and determining whether the speech input indicates a scenario creation intention to create a scenario;
an acquiring step: in the event of a positive determination result, acquiring scenario description information related to the scenario to be created; and
a generating step: on the basis of the scenario description information, generating a scenario file for scenario creation.

According to a second aspect of the present disclosure, provided is a scenario creation device for a vehicle, including:
a receiving apparatus configured to receive a speech input from a user of the vehicle;
a parsing and determining apparatus configured to parse the speech input and determine whether the speech input indicates a scenario creation intention to create a scenario;
an acquiring apparatus configured to, in the event of a positive determination result, acquire scenario description information related to the scenario to be created; and
a generating apparatus configured to, on the basis of the scenario description information, generate a scenario file for scenario creation.

According to a third aspect of the present disclosure, provided is a vehicle, including the scenario creation device according to the second aspect of the present disclosure.

According to a fourth aspect of the present disclosure, provided is a computer device, including a memory and a processor, wherein the memory stores thereon computer instructions that, when executed by the processor, cause the method according to the first aspect of the present disclosure to be performed.

According to a fifth aspect of the present disclosure, provided is a non-transitory computer-readable storage medium storing thereon computer instructions that, when executed by a processor, cause the method according to the first aspect of the present disclosure to be performed.

With the solution of the present disclosure, the vehicle user can realize scenario creation simply by providing speech input, enabling scenario creation to be triggered and realized with a natural language under various circumstances, without limitations. Therefore, the present disclosure eliminates the need for parking or other safety conditions required by existing scenario creation solutions, while offering a user-friendly method for scenario creation.

### BRIEF DESCRIPTION OF THE DRAWINGS

Non-limiting and non-exhaustive embodiments of the present disclosure are described by way of example with reference to the following drawings, wherein:

FIG. 1 shows a flowchart of a scenario creation method for a vehicle according to an embodiment of the present disclosure;

FIG. 2 shows a block diagram of a scenario creation device for a vehicle according to an embodiment of the present disclosure; and

FIG. 3 shows a scenario creation application for a vehicle according to an embodiment of the present disclosure.

### DETAILED DESCRIPTION OF THE EMBODIMENTS

To make the foregoing and other features and advantages of the present disclosure more apparent, the present disclosure is further described below with reference to the drawings. The drawings form a part of the present application and, together with embodiments of the present disclosure, serve to illustrate the present disclosure. For the sake of clarity and simplicity, detailed descriptions of the known functions and structures of the articles, apparatuses and/or devices described herein will be omitted where such details may obscure the subject matter of the present disclosure. It is to be understood that the specific embodiments provided herein are for explanatory purposes to those skilled in the art and are intended to be exemplary, not limiting.

The features described herein may be embodied in various forms and should not be interpreted as being limited to the embodiments described herein. Rather, the embodiments described herein are provided merely to illustrate some of many possible ways of implementing the apparatus and/or system described herein, which will be apparent upon understanding the disclosure of the present application.

As used herein, the term “and/or” includes any one of the associated listed items and any combination of any two or more of the associated listed items.

Although terms such as “first”, “second”, and “third” may be used herein to describe various members, components, parts, or elements, these members, components, parts, or elements are not limited by these terms. Rather, these terms are used only to distinguish one member, component, portion, or element from another member, component, part, or element. Thus, a first member, component, portion, or element referred to herein may also be referred to as a second member, component, portion, or element, without departing from the teachings of the present disclosure.

The terms used herein are merely for describing various embodiments and are not intended to limit the scope of the disclosure. Unless the context clearly indicates otherwise, the terms “a”, “an”, and “the” are also intended to include the plural forms. The terms “comprise”, “include”, and “have” specify the presence of the stated features, operations, members, elements, and/or a combination thereof, but do not preclude the presence or addition of one or more other features, operations, members, elements, and/or a combination thereof.

In the following description, numerous specific details are set forth to provide a thorough understanding of the present disclosure. However, it will be apparent to those of ordinary skill in the art that the specific details are not required to practice the present disclosure. In other cases, well-known steps or operations are not described in detail to avoid obscuring the present disclosure.

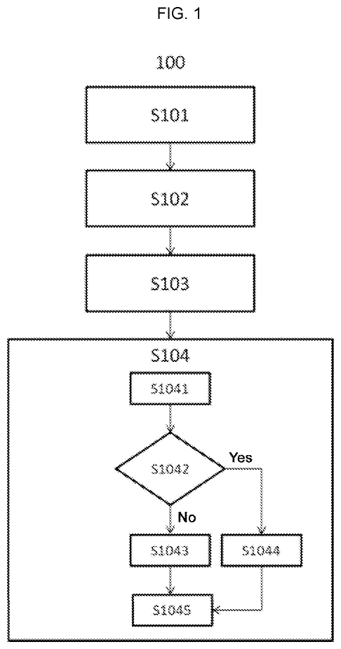

Referring to FIG. 1, a flowchart of a scenario creation method 100 for a vehicle according to an embodiment of the present disclosure is shown. The method 100 may include a receiving step S101, a parsing and determining step S102, an acquiring step S103, and a generating step S104.

At the receiving step S101, a speech input from a user of the vehicle may be received. In one embodiment, the speech input from the user of the vehicle may be received through a speech receiving device (such as a microphone) on the vehicle.

At the parsing and determining step S102, the speech input may be parsed and it is determined whether the speech input indicates a scenario creation intention to create a scenario. This parsing and determining may be implemented in various possible ways.

For example, in one embodiment, the parsing and determining step S102 may include recognizing words contained in the speech input and determining whether the words indicate a scenario creation intention to create a scenario. This involves the conversion from audio (speech) to text. In this regard, there are various existing implementation techniques, such as automatic speech recognition (ASR). This also involves a multi-intent understanding of the text. In this regard, there are various existing implementation techniques, such as natural language understanding (NLU).

In the event of a positive determination result being obtained in the parsing and determining step S102, the acquiring step S103 may be executed. At the acquiring step S103, scenario description information related to the scenario to be created may be acquired. The scenario description information may be acquired in various possible ways.

In one embodiment, information related to scenario creation is extracted from the speech input as the scenario description information. This involves the conversion from audio (speech) to text. In this regard, there are various existing implementation techniques, such as ASR. This also involves a multi-intent understanding of the text. In this regard, there are various existing implementation techniques, such as NLU.

In another embodiment, alternatively or additionally, the scenario description information is acquired by querying the user for the information related to scenario creation, and extracting, from the reply of the user to the querying, the information related to scenario creation as the scenario description information. Advantageously, the querying is performed in speech form, and the reply of the user to the querying is a speech reply. In this case, it involves the conversion from audio (speech) to text. In this regard, there are various existing implementation techniques, such as ASR. This also involves a multi-intent understanding of the text. In this regard, there are various existing implementation techniques, such as NLU. It is anticipated that the querying may be initiated when the scenario description information extracted from the speech input is insufficient. Additionally, the query-reply cycle may be repeated several times until the acquired scenario description information is sufficient. However, the present disclosure is not limited thereto.

In one embodiment, the acquired scenario description information may be considered sufficient when it includes information indicating: (1) an expected scenario creation condition; (2) at least one expected scenario construction element; and (3) an expected control mode in which each expected scenario construction element is expected to be controlled. However, the present disclosure is not limited thereto. For example, when the acquired scenario description information indicates one or two of (1) the expected scenario creation condition, (2) the expected scenario construction element, and (3) the expected control mode, it is anticipated that the acquired scenario description information is supplemented in a predetermined default manner to obtain scenario description information indicating all of (1) the expected scenario creation condition, (2) the expected scenario construction element, and (3) the expected control mode.

Here, the “expected scenario creation condition” refers to an expected condition for creating a scenario, and may be various possible conditions expected to trigger scenario creation. For example, the expected scenario creation condition may be some time, some place, or the like. The “expected scenario construction element” refers to an expected element involved in constructing a scenario, and may be various possible constituent elements constituting a scenario expected to be created. For example, the “expected scenario construction element” may be some vehicle component or onboard device (such as a seat, ambient light, and air conditioner), some entertainment element (such as music and video), and the like. For an expected scenario construction element, the “expected control mode” refers to the mode in which the expected scenario construction element is expected to be controlled, and may involve control of aspects of the expected scenario construction element. For example, the “expected control mode” may relate to the control of a state of a corresponding expected scenario construction element (such as an on/off state of an air conditioner, an inclination angle/height of a seat), a characteristic or parameter of a corresponding expected scenario construction element (such as a track/volume of music, a color/brightness of an ambient light), an activation time of a corresponding expected scenario construction element (such as an activation time of an air conditioner), and the like.

At the generating step S104, a scenario file for scenario creation may be generated on the basis of the acquired scenario description information. In one embodiment, the acquired scenario description information is further processed to obtain the scenario file. For example, as shown, the generating step S104 may include steps S1041, S1042, S1043, S1044, and S1045. Nonetheless, the present disclosure may anticipate generating the scenario file directly from the acquired scenario description information.

At step S1041, preliminary scenario data is generated on the basis of the acquired scenario description information, the preliminary scenario data indicating: (1) an expected scenario creation condition; (2) at least one expected scenario construction element; and (3) an expected control mode in which each expected scenario construction element is expected to be controlled.

At step S1042, it is checked whether the preliminary scenario data conforms to a predetermined standard related to vehicle control safety. In one embodiment, the check may include checking whether controlling each of the one or more expected scenario construction elements in a corresponding expected control mode conforms to the predetermined standard related to vehicle control safety. In another embodiment, the checking may include checking whether controlling each of the one or more expected scenario construction elements in a corresponding expected control mode under the expected scenario creation condition conforms to the predetermined standard related to vehicle control safety. The predetermined standard may be various possible standard related to vehicle control safety, and may relate to various possible elements, such as the scenario construction elements hereinabove. In one embodiment, when controlling some expected scenario construction element in a corresponding expected control mode violates vehicle safety regulations or may pose a vehicle safety risk, it may be considered that the predetermined standard related to vehicle control safety is not conformed to. In another embodiment, when controlling some expected scenario construction element in a corresponding expected control mode while controlling another expected scenario construction element in a corresponding expected control mode violates vehicle safety regulations or may pose a vehicle safety risk, it may be considered that the predetermined standard related to vehicle control safety is not conformed to.

In the event of the check result being positive in step S1042, the process proceeds to step S1044 where the preliminary scenario data is regarded as final scenario data.

In the event of the check result being negative in step S1042, the process proceeds to step S1043 where the preliminary scenario data is optimized to generate final scenario data. The preliminary scenario data may be optimized in various possible ways.

In one embodiment, in the event of the check result being negative, the preliminary scenario data may be automatically optimized to generate the final scenario data.

In another embodiment, in the event of the check result being negative, a suggestion related to scenario creation may be provided for the user, feedback from the user on the suggestion may be received, the preliminary scenario data may be optimized on the basis of the feedback, and the final scenario data may be generated on the basis of the optimized preliminary scenario data. In one embodiment, the preliminary scenario data is optimized through speech interactive confirmation and/or modification instructions in a speech interactive manner, with both the suggestion provided for the user and the feedback on the suggestion received from the user being in the form of speech. In this case, it involves the conversion from audio (speech) to text. In this regard, there are various existing implementation techniques, such as ASR. This also involves a multi-intent understanding of the text. In this regard, there are various existing implementation techniques, such as NLU. In other embodiments, alternatively or additionally, the suggestion related to scenario creation may be provided for the user and the feedback from the user on the suggestion may be received visually.

The final scenario data may indicate: (1)′ the actual scenario creation condition; (2)′ at least one actual scenario construction element; and (3)′ the actual control mode in which each of the actual scenario construction elements is actually controlled. The automatic optimization of the preliminary scenario data and the suggestion provided for the user may be based on the predetermined standard related to vehicle control safety, such that the resulting final scenario data conforms to the predetermined standard related to vehicle control safety. That is, controlling each of the at least one actual scenario construction element in a corresponding actual control mode under the actual scenario creation condition conforms to the predetermined standard related to vehicle control safety.

Here, the “actual scenario creation condition” refers to an actual condition for creating a scenario, and may be various possible conditions that actually trigger scenario creation. For example, the actual scenario creation condition may be some time, some place, or the like. The “actual scenario construction element” refers to an actual element involved in constructing a scenario, and may be various possible constituent elements constituting the scenario actually to be created. For example, the “actual scenario construction element” may be some vehicle component or onboard device (such as a seat, ambient light, and air conditioner), some entertainment element (such as music and video), and the like. For an actual scenario construction element, the “actual control mode” refers to the mode in which the actual scenario construction element is actually to be controlled, and may involve control of the aspects of the actual scenario construction element. For example, the “actual control mode” may relate to the control of a state of a corresponding actual scenario construction element (such as an on/off state of an air conditioner, an inclination angle/height of a seat), a characteristic or parameter of a corresponding actual scenario construction element (such as a track/volume of music, a color/brightness of an ambient light), an activation time of a corresponding actual scenario construction element (such as an activation time of an air conditioner), and the like.

At step S1045, the scenario file is generated for scenario creation on the basis of the final scenario data. This may be implemented in various possible ways.

In one embodiment, generating the scenario file on the basis of the final scenario data includes storing the final scenario data as an executable scenario file.

In another embodiment, the final scenario data is in the form of natural language, and the scenario file uses a JSON text structure. In this case, step S104 may include the following sub-steps: at a first sub-step, the final scenario data is converted into a syntax tree; and at a second sub-step, the converted syntax tree (natural language syntax tree) is mapped to a domain specific language (DSL) used to describe the scenario, to construct the scenario DSL syntax tree, and the constructed scenario DSL syntax tree is then serialized into domain specific language description content of the scenario as a scenario file, where the domain specific language description content may be in the form of a JSON text structure. The first sub-step involves grammatical analysis of natural language, more particularly, a grammatical analysis technique for converting natural language into a syntax tree. In this regard, there are various existing implementation techniques, such as a syntax analyzer in existing compiler systems. The second sub-step may also adopt existing implementation techniques, and will not be described in detail here.

It is anticipated that the scenario creation method of the present disclosure may further include: when the actual scenario creation condition is satisfied, using the scenario file to create a scenario in the vehicle such that each of the one or more actual scenario construction elements is controlled in a corresponding actual control mode in the created scenario. In one embodiment, the scenario file contains domain specific language description content of the scenario (such as a JSON text structure). In this case, the scenario is created by parsing the domain specific language description content of the scenario, and performing various operations defined therein, such as controlling each of the actual scenario construction elements, which can be achieved by the corresponding DSL execution module.

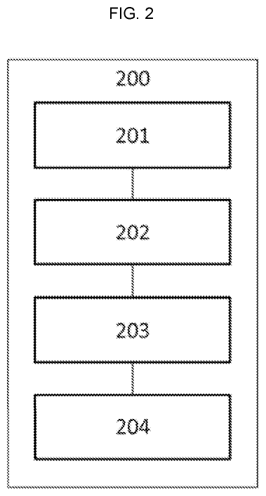

Referring to FIG. 2, a block diagram of a scenario creation device 200 for a vehicle according to an embodiment of the present disclosure is shown. The device 200 may include a receiving apparatus 201, a parsing and determining apparatus 202, an acquiring apparatus 203, and a generating apparatus 204.

The receiving apparatus 201 may be configured to receive a speech input from a user of the vehicle.

The parsing and determining apparatus 202 may be configured to parse the speech input and determine whether the speech input indicates a scenario creation intention to create a scenario. In one embodiment, the parsing and determining apparatus 202 may be configured to recognize words contained in the speech input and determine whether the words indicate a scenario creation intention to create a scenario.

The acquiring apparatus 203 may be configured to, in the event of a positive determination result, acquire scenario description information related to the scenario to be created. In one embodiment, the acquiring apparatus 203 may be configured to: in the event of a positive determination result, extract, from the speech input, information related to scenario creation as the scenario description information related to the scenario to be created; and/or in the event of a positive determination result, query the user for the information related to scenario creation, and extract, from the reply of the user to the querying, information related to scenario creation as the scenario description information related to the scenario to be created.

The generating apparatus 204 may be configured to generate a scenario file for scenario creation on the basis of the scenario description information. In one embodiment, the generating apparatus 204 may be configured to: generate preliminary scenario data on the basis of the scenario description information, the preliminary scenario data indicating an expected scenario creation condition, one or more expected scenario construction elements, and an expected control mode in which each of the expected scenario construction elements is expected to be controlled; check whether controlling each of the one or more expected scenario construction elements in a corresponding expected control mode conforms to a predetermined standard related to vehicle control safety; in the event of a negative check result, optimize the preliminary scenario data to generate final scenario data; and on the basis of the final scenario data, generate the scenario file for scenario creation. The final scenario data may indicate: (1)′ an actual scenario creation condition; (2)′ at least one actual scenario construction element; and (3)′ an actual control mode in which each of the actual scenario construction elements is actually be controlled.

It is anticipated that the scenario creation device of the present disclosure may further include a scenario creation apparatus that is configured to: when the actual scenario creation condition is satisfied, use the scenario file to create a scenario in the vehicle such that each of the one or more actual scenario construction elements is controlled in a corresponding actual control mode in the created scenario.

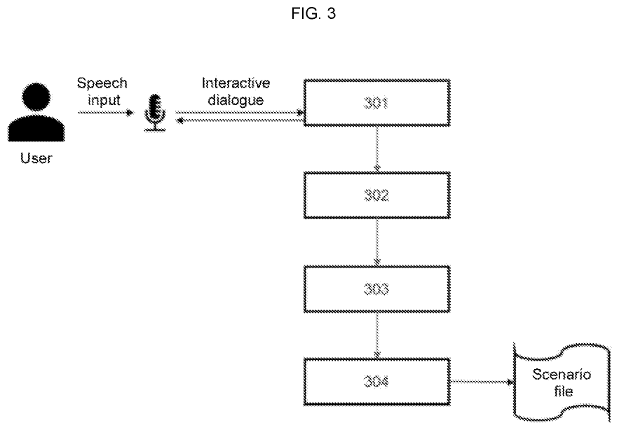

FIG. 3 shows a scenario creation application for a vehicle according to an embodiment of the present disclosure.

At block 301, the user may provide, via a speech receiving apparatus (e.g., a microphone) of the vehicle, a speech input indicating a scenario creation intention, such as “I want to create a scenario to play music when I finish work”. A speech processing apparatus (not shown) of the vehicle may parse the speech input of the user, recognize the scenario creation intention, and acquire the relevant scenario description information (corresponding to steps S101 and S102 above). In terms of acquiring scenario description information, information related to scenario creation may be extracted from the speech input of the user as scenario description information. When necessary, the scenario description information may be acquired through an interactive dialogue, that is, a speech output apparatus (not shown) of the vehicle queries the user for the information related to scenario creation in a speech manner, and the speech reply of the user to the querying is received through the speech receiving apparatus of the vehicle. The information related to scenario creation is then extracted from the reply as scenario description information through the speech processing apparatus of the vehicle. For further details, reference may be made to the related descriptions above. In this case, the speech receiving apparatus, the speech processing apparatus, and the speech output apparatus of the vehicle constitute an interactive dialogue system (which may also be referred to as a “vehicle scenario dialogue system”).

Upon acquiring the relevant scenario description information, at block 302, preliminary scenario data is generated on the basis of the scenario description information, the preliminary scenario data indicating an expected scenario creation condition, one or more expected scenario construction elements, and an expected control mode in which each of the expected scenario construction elements is expected to be controlled. The scenario description information may be used to generate preliminary scenario data through a trained Al model, allowing the generated preliminary scenario data to be used for the automatic creation of a scenario. In this sense, block 302 may constitute a vehicle scenario generator.

Then, at block 303, it is checked whether controlling each of the one or more expected scenario construction elements in a corresponding expected control mode conforms to a predetermined standard related to vehicle control safety. In this sense, block 303 may constitute a vehicle control configuration safety check module.

In the event of a negative check result, then, at block 304, a suggestion related to scenario creation is visually provided for the user, feedback from the user on the suggestion is received, and the preliminary scenario data is optimized on the basis of the feedback to generate final scenario data. As understood by those skilled in the art, the suggestion may be displayed on an existing visual editor on which the user may make manual adjustments to input feedback. In this sense, block 304 may constitute a visual editor. Similarly, a trained Al model may be used here, and the generated final scenario data may be used for the automatic creation of a scenario.

The resulting final scenario data may be stored as a scenario file, to be called upon the actual scenario creation condition is satisfied, in order to create the scenario.

The present disclosure further provides a vehicle that includes the scenario creation device for a vehicle according to the present disclosure.

It is to be understood that the specific features, operations, and details described herein with respect to the scenario creation method of the present disclosure may be similarly applied to the scenario creation device of the present disclosure, or vice versa. In addition, each step of the scenario creation method of the present disclosure described above may be performed by a corresponding constituent part or apparatus of the scenario creation device of the present disclosure.

It is to be understood that the apparatuses of the scenario creation device of the present disclosure may be implemented in whole or in part by software, hardware, firmware, or a combination thereof. The apparatuses may each be embedded as hardware or firmware within or independent of the processor of the computer device, or may be stored as software in the memory of the computer device for the processor to call to perform the operation of the apparatuses. The apparatuses may each be implemented as a separate component or module, or two or more apparatuses may be implemented as a single component or module.

It should be understood by those of ordinary skill in the art that the schematic diagram of the device shown in FIG. 2 is merely an exemplary block diagram illustrating a partial structure related to the solution of the present disclosure, and does not limit the computer device, processor, or computer program embodying the solution of the present disclosure. A specific computer device, processor, or computer program may include more or fewer components or modules than those shown in the drawings, or may combine or separate certain components or modules, or may have a different arrangement of components or modules.

In one embodiment, there is provided a computer device including a memory and a processor, wherein the memory stores thereon computer instructions executable by the processor; and the computer instructions, when executed by the processor, instruct the processor to perform the steps of the method of the present disclosure. The described vehicle may include the computer device. The computer device may broadly be a server, an onboard terminal, or any other electronic device with the necessary computing and/or processing capabilities. In one embodiment, the computer device may include a processor, a memory, a network interface, a communication interface, and the like connected by a system bus. The processor of the computer device may be configured to provide necessary computing, processing, and/or control capabilities. The memory of the computer device may include a non-volatile storage medium and an internal memory. An operating system, a computer program, and the like may be stored in or on the non-volatile storage medium. The internal memory may provide an environment for the operation of the operating system and the computer program in the non-volatile storage medium. The network interface and the communication interface of the computer device may be configured to connect and communicate with external devices over a network. The computer program, when executed by the processor, performs the steps of the method of the present disclosure.

The present disclosure may be implemented as a computer-readable storage medium storing thereon a computer program that, when executed by the processor, causes the steps of the method of the present disclosure to be performed. The described vehicle may include the computer-readable storage medium and the processor. In one embodiment, the computer program is distributed over a plurality of computer devices or processors coupled by a network such that the computer program is stored, accessed, and executed by one or more computer devices or processors in a distributed manner. A single method step/operation, or two or more method steps/operations, may be performed by a single computer device or processor or by two or more computer devices or processors. One or more method steps/operations may be performed by one or more computer devices or processors, and one or more other method steps/operations may be performed by one or more other computer devices or processors. One or more computer devices or processors may perform a single method step/operation, or may perform two or more method steps/operations.

It will be understood by those of ordinary skill in the art that a computer program may instruct related hardware, such as a computer device or processor, to perform all or part of the operations of the method of the present disclosure. The computer program may be stored in a non-transitory computer-readable storage medium. The computer program, when executed, causes the operations of the method of the present disclosure to be performed. Any reference herein to the memory, storage, database, or other media may include non-volatile and/or volatile memories, as appropriate. Examples of the non-volatile memory include a read-only memory (ROM), a programmable ROM (PROM), an electrically programmable ROM (EPROM), an electrically erasable programmable ROM (EEPROM), a flash memory, a magnetic tape, a floppy disk, a magneto-optical data storage apparatus, an optical data storage apparatus, a hard disk, a solid-state drive, and the like. Examples of the volatile memory include a random-access memory (RAM), an external cache memory, and the like. The technical features described above may be arbitrarily combined.

The technical features described above may be arbitrarily combined. Although not all possible combinations of these technical features have been described, any combination of these technical features is to be considered as being encompassed by the specification, provided that such combinations are not contradictory.

Although the present disclosure has been described in conjunction with embodiments, it is to be understood by those skilled in the art that the description and the drawings hereinabove are merely exemplary and not limiting, and that the present disclosure is not limited to the disclosed embodiments. Various modifications and variations are possible without departing from the spirit of the present disclosure.

1. A scenario creation method for a vehicle, comprising:
a receiving step: receiving a speech input from a user of the vehicle;
a parsing and determining step: parsing the speech input and determining whether the speech input indicates a scenario creation intention to create a scenario;
an acquiring step: in the event of a positive determination result, acquiring scenario description information related to the scenario to be created; and
a generating step: on the basis of the scenario description information, generating a scenario file for scenario creation.

2. The scenario creation method according to claim 1, wherein the parsing and determining step comprises:
recognizing words contained in the speech input and determining whether the words indicate a scenario creation intention to create a scenario.

3. The scenario creation method according to claim 1, wherein the acquiring step comprises:
in the event of a positive determination result, extracting, from the speech input, information related to scenario creation as the scenario description information related to the scenario to be created; and/or
in the event of a positive determination result, querying the user for information related to scenario creation, and extracting, from the reply of the user to the querying, information related to scenario creation as the scenario description information related to the scenario to be created.

4. The scenario creation method according to claim 1, wherein the generating step comprises:
generating preliminary scenario data on the basis of the scenario description information, the preliminary scenario data indicating an expected scenario creation condition, one or more expected scenario construction elements, and an expected control mode in which each of the expected scenario construction elements is expected to be controlled;
checking whether controlling each of the one or more expected scenario construction elements in a corresponding expected control mode conforms to a predetermined standard related to vehicle control safety;
in the event of a negative check result, optimizing the preliminary scenario data to generate final scenario data; and
on the basis of the final scenario data, generating the scenario file for scenario creation.

5. The scenario creation method according to claim 4, wherein in the event of a negative check result, optimizing the preliminary scenario data to generate final scenario data comprises:
in the event of a negative check result, providing the user with a suggestion related to scenario creation, receiving feedback from the user on the suggestion, optimizing the preliminary scenario data on the basis of the feedback, and generating the final scenario data on the basis of the optimized preliminary scenario data; and/or
in the event of a negative check result, optimizing automatically the preliminary scenario data to generate the final scenario data.

6. The scenario creation method according to claim 4, wherein the final scenario data indicates an actual scenario creation condition, one or more actual scenario construction elements, and an actual control mode in which each of the actual scenario construction elements is actually to be controlled, the scenario creation method further comprising:
when the actual scenario creation condition is satisfied, using the scenario file to create a scenario in the vehicle such that each of the one or more actual scenario construction elements is controlled in a corresponding actual control mode in the created scenario.

7. (canceled)

8. (canceled)

9. (canceled)

10. (canceled)

11. (canceled)

12. (canceled)

13. A vehicle, comprising a computer device, the computer device comprising a memory and a processor, wherein the memory stores computer instructions on a non-transitory computer-readable storage medium that, when executed by the processor, cause the processor to:
receive a speech input from a user of the vehicle;
parse the speech input and determine whether the speech input indicates a scenario creation intention to create a scenario;
in the event of a positive determination result, acquire scenario description information related to the scenario to be created; and
on the basis of the scenario description information, generate a scenario file for scenario creation

14. (canceled)

15. A non-transitory computer-readable storage medium storing thereon computer instructions that, when executed by a processor, cause the processor to:
receive a speech input from a user of the vehicle;
parse the speech input and determine whether the speech input indicates a scenario creation intention to create a scenario;
in the event of a positive determination result, acquire scenario description information related to the scenario to be created; and
on the basis of the scenario description information, generate a scenario file for scenario creation

16. The vehicle according to claim 13, wherein the processor is further caused to:
recognize words contained in the speech input and determine whether the words indicate a scenario creation intention to create a scenario.

17. The vehicle according to claim 13, wherein the processor is further caused to:
in the event of a positive determination result, extract, from the speech input, information related to scenario creation as the scenario description information related to the scenario to be created; and/or
in the event of a positive determination result, query the user for information related to scenario creation, and extract, from the reply of the user to the querying, information related to scenario creation as the scenario description information related to the scenario to be created.

18. The vehicle according to claim 13, wherein the processor is further caused to:
generating preliminary scenario data on the basis of the scenario description information, the preliminary scenario data indicating an expected scenario creation condition, one or more expected scenario construction elements, and an expected control mode in which each of the expected scenario construction elements is expected to be controlled;
checking whether controlling each of the one or more expected scenario construction elements in a corresponding expected control mode conforms to a predetermined standard related to vehicle control safety;
in the event of a negative check result, optimizing the preliminary scenario data to generate final scenario data; and
on the basis of the final scenario data, generating the scenario file for scenario creation.

19. The vehicle according to claim 18, wherein the processor is further caused to:
in the event of a negative check result, provide the user with a suggestion related to scenario creation, receive feedback from the user on the suggestion, optimize the preliminary scenario data on the basis of the feedback, and generating the final scenario data on the basis of the optimized preliminary scenario data; and/or
in the event of a negative check result, optimize automatically the preliminary scenario data to generate the final scenario data.

20. The vehicle according to claim 18, wherein the final scenario data indicates an actual scenario creation condition, one or more actual scenario construction elements, and an actual control mode in which each of the actual scenario construction elements is actually to be controlled, the processor is further caused to:
when the actual scenario creation condition is satisfied, use the scenario file to create a scenario in the vehicle such that each of the one or more actual scenario construction elements is controlled in a corresponding actual control mode in the created scenario.

21. The non-transitory computer-readable storage medium according to claim 15, wherein the processor is further caused to:
recognize words contained in the speech input and determine whether the words indicate a scenario creation intention to create a scenario.

22. The non-transitory computer-readable storage medium according to claim 15, wherein the processor is further caused to:
in the event of a positive determination result, extract, from the speech input, information related to scenario creation as the scenario description information related to the scenario to be created; and/or
in the event of a positive determination result, query the user for information related to scenario creation, and extract, from the reply of the user to the querying, information related to scenario creation as the scenario description information related to the scenario to be created.

23. The non-transitory computer-readable storage medium according to claim 15, wherein the processor is further caused to:
generating preliminary scenario data on the basis of the scenario description information, the preliminary scenario data indicating an expected scenario creation condition, one or more expected scenario construction elements, and an expected control mode in which each of the expected scenario construction elements is expected to be controlled;
checking whether controlling each of the one or more expected scenario construction elements in a corresponding expected control mode conforms to a predetermined standard related to vehicle control safety;
in the event of a negative check result, optimizing the preliminary scenario data to generate final scenario data; and
on the basis of the final scenario data, generating the scenario file for scenario creation.

24. The non-transitory computer-readable storage medium according to claim 23, wherein the processor is further caused to:
in the event of a negative check result, provide the user with a suggestion related to scenario creation, receive feedback from the user on the suggestion, optimize the preliminary scenario data on the basis of the feedback, and generating the final scenario data on the basis of the optimized preliminary scenario data; and/or
in the event of a negative check result, optimize automatically the preliminary scenario data to generate the final scenario data.

25. The non-transitory computer-readable storage medium according to claim 23, wherein the final scenario data indicates an actual scenario creation condition, one or more actual scenario construction elements, and an actual control mode in which each of the actual scenario construction elements is actually to be controlled, the processor is further caused to:
when the actual scenario creation condition is satisfied, use the scenario file to create a scenario in the vehicle such that each of the one or more actual scenario construction elements is controlled in a corresponding actual control mode in the created scenario.

26. The scenario creation method according to claim 2, wherein the acquiring step comprises:
in the event of a positive determination result, extracting, from the speech input, information related to scenario creation as the scenario description information related to the scenario to be created; and/or
in the event of a positive determination result, querying the user for information related to scenario creation, and extracting, from the reply of the user to the querying, information related to scenario creation as the scenario description information related to the scenario to be created.

27. The scenario creation method according to claim 5, wherein the final scenario data indicates an actual scenario creation condition, one or more actual scenario construction elements, and an actual control mode in which each of the actual scenario construction elements is actually to be controlled, the scenario creation method further comprising:
when the actual scenario creation condition is satisfied, using the scenario file to create a scenario in the vehicle such that each of the one or more actual scenario construction elements is controlled in a corresponding actual control mode in the created scenario.
